(19) United States
(12) Patent Application Publication
(10) Pub. No.: US 2019/0039442 A1
(43) Pub. Date: Feb. 7, 2019

(54) MOTOR VEHICLE DOOR, STRUCTURAL UNIT, GLAZED UNIT, CORRESPONDING MANUFACTURING METHOD AND VEHICLE

(71) Applicant: ADVANCED COMFORT SYSTEMS FRANCE SAS - ACS FRANCE, Bressuire (FR)

(72) Inventors: Philippe CHARGE, Bressuire (FR); Stéphane MOREAU, Le Temple (FR); Julien SEILLER, Bressuire (FR)

(21) Appl. No.: 15/857,962

(22) Filed: Dec. 29, 2017

Related U.S. Application Data
(60) Provisional application No. 62/440,445, filed on Dec. 30, 2016.

(51) Int. Cl. B60J 5/04; E05D 15/16; B60J 5/10; B60J 1/17; B60J 1/18

(52) U.S. Cl. CPC B60J 5/0402; E05D 15/165; B60J 5/0412; B60J 5/0465; E05Y 2900/55; B60J 5/10; B60J 1/17; B60J 1/1861; E05Y 2900/531; B60J 5/0468

(57) ABSTRACT

The invention relates to a motor vehicle door comprising a structure-forming unit and a glazed unit assembled with each other. According to the invention, the structure-forming unit has a first frame and said glazed unit has a second frame, said first frame and said second frame being essentially superimposed, said first frame and/or said second frame bear at least one complementary centering element enabling them to be assembled, each centering element controlling the position of the second frame relative to said first frame along at least one direction, said first frame and/or said second frame bear fixed-attachment elements enabling definitive attachment to each other, said second frame comprises two guide rails slidingly guiding a mobile glazed panel between a closed position and at least one open position, said mobile glazed panel resting, in closed position, against said second frame such that the latter is situated between said first frame and said mobile glazed panel, said mobile glazed panel bears, on its face oriented towards the interior of the vehicle, at least two guide skids, each mounted so as to be sliding relative to one of said guide rails, and the position of at least one of said skids relative to said mobile glazed panel is adjustable.

### BACKGROUND OF THE INVENTION

### Field of the Invention

The field of the invention is that of bay windows made in vehicle doors. More particularly, the invention relates to devices for closing off a bay window made in a door of a motor vehicle and comprising a part that is mobile, for example mobile in an essentially vertical direction, capable of closing off or releasing an aperture or opening.

More specifically, the invention relates to motor vehicle doors equipped with at least one glazed panel that is mobile in a substantially vertical direction, especially to pass from a closed position to an open position in which it totally or partially penetrates into a lower door shell (the mobile panel being capable naturally of generally taking a plurality of intermediate positions).

Such a vehicle door can especially be a side door but the invention can also apply for example to the swinging and/or sliding doors of a vehicle, including rear doors, hatchback doors etc.

### Description of the Related Art

Conventionally, a bay window of a vehicle, whether for an automobile, a utility vehicle, a truck, a bus or a railway bogie, is closed off by adding on a glass window held by a connecting frame. This frame has an inside portion and an outside portion that simultaneously grip the edges of the glazed panel, with a seal lining.

The most commonly and widely used technique for opening and closing a glazed panel is to make it vertically mobile in its own plane by making it enter or exit the door shell or the lining of the side doors.

This technique is now commonly used and solutions to automate it are known. Equipping motor vehicles with electric windows is now very widespread.

At the same time, another technique has been proposed by the holder of the present patent application. The basic principles of this technique are described especially in the patent documents EP 0778168 and EP 0857844.

This technique is used to produce flush bay windows which, in esthetic terms and seen from the exterior, have a smooth flush appearance because no frame is needed.

Flush bay windows include a fixed assembly or unit and a mobile portion, the fixed unit being intended for mounting in a housing defined for this purpose in the bodywork of the vehicle.

Now, the bays made in the doors have relatively limited dimensions. It is therefore generally not convenient to further reduce these dimensions by adding on a fixed unit according to the prior art.

However, it is desirably to be able to equip certain vehicles with flush bay windows.

Besides, the movement of the mobile panel needs to be precise and efficient. It must be easy to assemble, and this assembling to take into account its relatively high tolerance values and precise contact or touching (play) with the surroundings of the glass window that may exist from one vehicle to another.

It is also important that automobile manufacturers should be able to carry out this assembling or joining operation speedily and simply without a multiplicity of settings and adjustments as regards sliding, tight sealing, alignment with other elements of the vehicle etc.

### SUMMARY OF THE INVENTION

The invention is notably aimed at overcoming at least some of these drawbacks of the prior art. Therefore, the invention relates to a motor vehicle door comprising a structure-forming unit and a glazed unit assembled or joined with each other. According to the invention, said structure-forming unit has a first frame and said glazed unit has a second frame, said first frame and said second frame being essentially superimposed, said first frame and/or said second frame bearing at least one complementary centering element enabling them to be assembled, each centering element controlling the position of the second frame relative to the first frame in at least one direction, said first frame and/or said second frame bearing fixed-attachment elements enabling definitive attachment to each other, said second frame comprising two guide rails slidingly guiding a mobile glazed panel between a closed position and at least one open position, said mobile glazed panel being supported or resting, in closed position, against said second frame such that the latter is situated between said first frame and said mobile glazed panel, said mobile glazed panel bearing, on its face oriented towards the interior of the vehicle, at least two guide skids mounted slidingly relative to one of said guide rails, and the position of at least one of said skids relative to said mobile glazed panel being adjustable.

Thus, a vehicle door with sliding window is made simply and efficiently, the sliding glass window having a flush appearance wherein it is possible to have a precise positioning of the glazed panel, through the adjusting of the skids and therefore efficient functioning and tightly sealed closure for each device and each door despite the tolerance values required to manufacture and assemble vehicles.

The joining of the two assemblies and especially the two frames is easy and speedy because of the presence of centering elements.

The glazed unit is prepared for example at the plant of a manufacturer or sub-contractor distinct from the automobile manufacturer, and the totality or at least the essential part of the adjustments are made beforehand. The manufacturer only needs to assemble and fixedly attach the two assemblies.

According to one particular embodiment, said centering elements comprise an element for centering in a direction X that is substantially horizontal and substantially in the general plane of said door and an element for centering in a substantially vertical direction Z.

As a complement or a variant, said centering elements can comprise an element for centering in two substantially perpendicular directions, one direction X that is substantially horizontal and substantially in the general plane of said door and one substantially vertical direction Z.

According to one particular embodiment, said fixed-attachment elements comprise screws.

As a complement or as a variant, said fixed-attachment elements comprise clips.

According to one particular embodiment, each of the skids of adjustable position is mounted on a skid support cooperating with a stud fixedly attached to said mobile glazed panel.

In this case, said skid support can have an aperture crossed by said stud, the dimensions of said aperture being greater than the diameter of said stud so as to enable a shifting of the adjustment relative to one another in at least one of two directions defining the plane of said glazed panel in the vicinity of said stud.

Said stud can especially be mounted on a saddle fixedly attached to said mobile glazed panel by gluing.

According to one particular implementation, said stud has a screw thread receiving a lock nut.

In one particular embodiment, said stud is concealed by a packing seal.

According to an optional aspect, the device will include anti-intrusion means, when said mobile glazed panel is in a closed position, comprising at least one hook cooperating with at least one element for receiving said hook, a first of these elements being fixed relative to a frame or to an upright that bears said guide rail or rails and a second one of these elements being fixedly attached to said mobile glazed panel.

This prevents a malicious individual from being able to act on the upper part of the mobile panel to move it outwards, for example in order to introduce a tool and try to open the door.

According to one particular embodiment, said hook is formed in or mounted on said frame or said upright and said receiving element is mounted on said mobile glazed panel.

According to one particular embodiment, said hook is formed in or mounted on said frame or said upright and said receiving element is mounted on a support of one another said skids.

According to another optional aspect, said rails can be configured to guide said mobile glazed panel in a swinging and sliding motion so as to move said mobile glazed panel slightly away, during its movement, from a frame or an upright against which it rests in a closed position.

In this case, at least one of said guide rails has a ramp that enables said swinging motion.

According to another optional aspect, at least one of said guide rails has an essentially circular section, said corresponding skid or skids also having an essentially circular section.

This cylindrical shape can especially facilitate the mounting and tolerate clearances. Other sections of the rails and skids respectively, for example rectangular or square sections, are also possible.

According to another optional aspect, at least one of said rails has a lower skid and upper skid, and said lower skid is guided so that said mobile glazed panel is under stress against a stop, in the vicinity of its upper part, when it is in its closed position.

Said stop can especially be fixedly attached to a frame, an upright or a window slider seal.

Said glazed unit can have at least one extension designed to penetrate the interior of said structure-forming unit.

This extension thus plays a role in the fastening of the glazed unit into the structure-forming unit and can play a role in the guidance and holding of the mobile panel.

According to one particular embodiment, said glazed unit comprises two extensions extending respectively in the extension of two uprights of said second frame.

According to one particular embodiment, said guiding means have swinging means, moving said glazed panel away from said second frame before it slides, and placing said glazed panel flat against said second frame in a closed position.

In other words, the glazed panel is placed flat against the second frame in closed position but is separated from it as soon as it is in motion. This especially has the advantage of preventing friction.

Said glazed unit can be provided with power means for driving said glazed panel.

In one particular embodiment of the invention, said powering means are mounted on a cross member connecting said extensions.

Notably, said drive means can act on sliding skids fixedly attached to said glazed panel.

According to a particular approach of the invention, said second frame is monoblock frame.

Said second frame can be made out of plastic.

In one particular embodiment of the invention, said second frame integrates at least one of the parts of the means for driving and guiding said glazed panel and/or at least one part of the means for receiving a gasket.

Thus, a multi-function integration is obtained, making it possible to eliminate parts and simplify assembly.

According to another mode of implementing the invention, said second frame is made out of at least two parts soldered to each other.

Notably, said second frame can comprise two uprights and an upper cross member that are to be joined with said uprights after the joining of said structure-forming unit and said glazed unit.

In one particular embodiment of the invention, said first and second frames are joined by fastening means made of plastic.

Such fastening means avert the problems of galvanic corrosion or galvanic effect.

According to one particular embodiment, the door comprises means of compensating for play between said first and second frames and/or setting the position of the said second frame.

It is thus possible to obtain a perfectly fitted flush appearance.

According to one particular characteristic of the invention, said glazed unit carries at least one B-pillar trim molding and/or rear view mirror trim molding flush with said glazed panel in the closed position.

The invention also relates to the structure-forming units and the glazed units for a motor vehicle door as described here above.

The invention also relates to a method for manufacturing and assembling a motor vehicle door of this kind. Such a method comprises an assembling step to superimpose said first frame and said second frame, said second frame comprising means for guiding a glazed panel slidingly mobile between a closed position and at least one open position and resting, in the closed position, against said second frame, so that this second frame is situated between said first frame and said mobile glazed panel.

According to one particular approach, the method of manufacture according to the invention more specifically comprises the following steps:
making said structure-forming unit having an opening to receive said glazed unit;
making said glazed unit, having at least one extension designed to penetrate the interior of said structure-forming unit;
introducing said extensions into said opening until a stop;
fixedly attaching said first and second frames.

In particular, the method can comprise:
a step for manufacturing said glazed unit comprising steps for:
mounting and/or forming two guide rails on said second frame, these two guide rails being capable of slidingly guiding a mobile glazed panel between a closed position and at least one open position, said mobile glazed panel resting, in closed position, against said second frame so that the second frame is situated between said first frame and said mobile glazed panel,
mounting at least two guiding skids on the face of said mobile glazed panel oriented towards the interior of the vehicle, each guiding skid being mounted slidingly relative to one of said guide rails,
placing said skids in said rails,
setting the position of at least one of said skids relative to said mobile glazed panel so as to enable the sliding of said skids in said rails,
and a step of assembling so as to superimpose said first frame and said second frame comprising the steps of:
placing said second frame relative to said first frame by means of at least one centering element provided on said first frame and/or said second frame and controlling the position of the second frame relative to said first frame according to at least one direction,
fixedly attaching said first frame to said second frame enabling definitive fastening to each other.

According to one particular implementation, said step for manufacturing said glazed unit is made at a first place so as to provide a pre-equipped glazed unit and said assembling step is performed by an automobile manufacturer without requiring a setting of the mobile glazed panel relative to said structure-forming unit and the chassis of said vehicle.

According to one particular characteristic, said step of manufacture comprises a step for positioning a movable stop that blocks said mobile panel in the closed position during its transport and said step of assembling.

According to one particular embodiment, the step of fixed attachment comprises at least one of the following steps:
gluing;
plastic clipping on;
screwing.

The invention also relates to a motor vehicle comprising at least one door according to at least certain of the characteristics described here above.

### BRIEF DESCRIPTION OF THE DRAWINGS

Other features and advantages of the invention shall appear more clearly from the following description of a preferred embodiment of the invention given by way of an illustratory and non-exhaustive example and from the appended drawings, of which:

FIG. 1 is a view of the structure-forming unit of a vehicle door according to the invention;

FIG. 2 presents a schematic view in section of the view of FIG. 1;

FIG. 3 is a view of the glazed unit;

FIG. 4 presents the assembling or joining of a glazed unit with the structure-forming unit;

FIGS. 5A, 5B and 5C give a schematic view in section of this assembling or joining operation:

FIG. 5A: a position corresponding to that of FIG. 4;

FIG. 5B: the two units are applied to each other;

FIG. 5C: the two units are in their definitive position and can be affixed;

FIG. 6 illustrates the frame of the door, in a section view, showing the frame of the structure and the frame of the glazed unit joined together;

FIG. 7 shows a mode of attachment of the frame of the structure and of the frame of the glazed unit;

FIG. 8 is a schematic view of a monoblock glazed unit;

FIG. 9 is a schematic illustration of a glazed unit made in several parts that are to be welded to each other;

FIG. 10 presents a side rear-view mirror of a motor vehicle and its trim molding according to the invention;

FIG. 11 presents the upper corner of a motor vehicle door according to the invention;

FIG. 12 is a graph of the different steps of a method for making an motor vehicle door according to the invention;

FIGS. 13A and 13B present another example of a door according to the invention, the mobile part being respectively in the closed position and in the open position;

FIG. 14 illustrates the glazed device of the door of FIGS. 13A and 13B;

FIG. 15 is an example of the means for setting the position of the mobile glazed panel according to the invention;

FIG. 16 is a view in section AA of a portion of FIG. 13A also presenting setting means;

FIG. 17 presents the same elements as FIG. 16 equipped with a lining seal;

FIG. 18 presents a first embodiment of the guide skids;

FIGS. 19A and 19B illustrate a second mode of implementing the guiding means, especially with a skid having an essentially circular section enabling guidance in two directions, for the rear rail (FIG. 19A);

FIG. 20 presents a view in section of means ensuring that the glass window is well framed in the closed position according to one embodiment;

FIGS. 21A and 21B illustrate a rear door and a front door respectively and especially the associated centering and fastening zones.

### DETAILED DESCRIPTION

The invention therefore presents a novel technique for making motor vehicle doors having a flush appearance. According to the invention, it is possible to make a door (side door, rear door, hatchback, cab door etc.), the window or mobile panel of which is perfectly aligned and flush with the bodywork (lower shell of the door) without even a gasket appearing between the door shell and the glazed panel, in the closed position. According to this technique, the door can have door frame that is swaged with the lining.

### 1. Manufacture and Assembling of the Door

Here below, we describe a side door, the glass window of which slides vertically within the door shell. Naturally, this technique can be adapted to other doors and the panel can be made to slide horizontally, or more generally in any direction whatsoever. There can also be several distinct glazed panels, some of which can be fixed.

A vehicle door according to the invention therefore comprises:
a structure-forming unit, for example made of sheet metal, corresponding to the door shell and having a first frame;
a glazed unit having a second frame configured so as to offer a flush appearance.

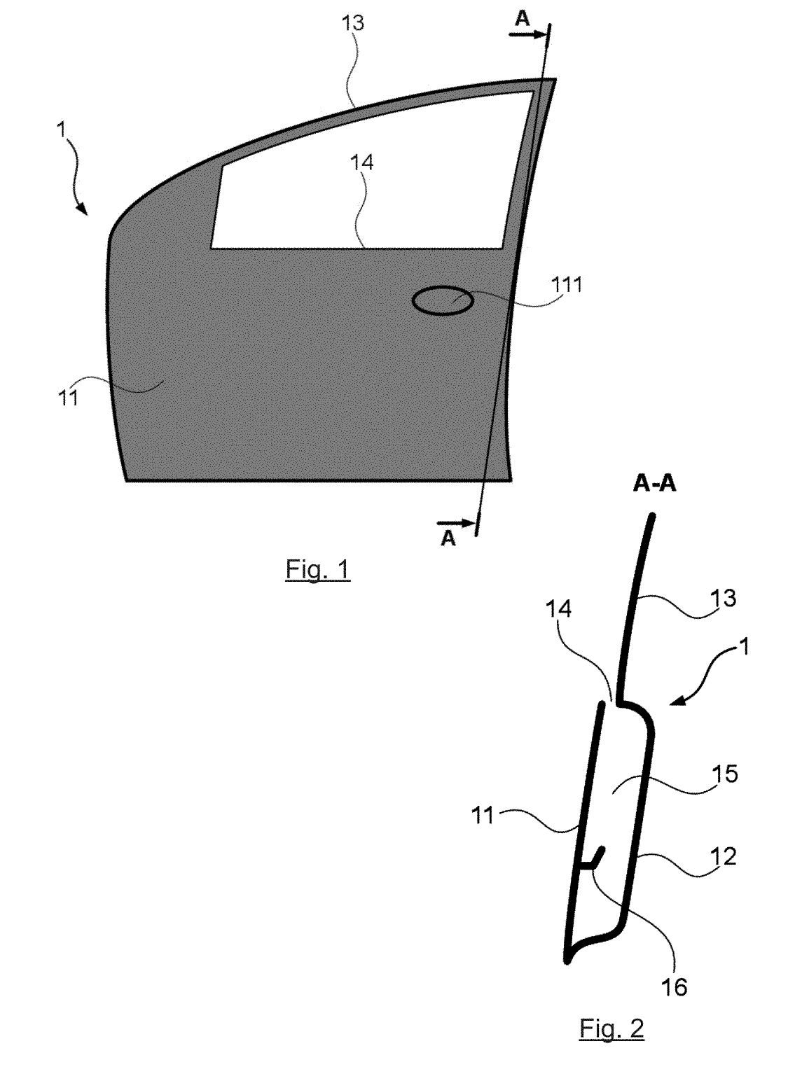

FIG. 1 is a simplified view of the structure-forming unit 1 of a motor vehicle door. FIG. 2 is a view in section of FIG. 1, at the level of the highest upright.

This door structure classically comprises an external panel 11 that is an integral part of the bodywork of the vehicle, and a lining 12, or cladding. The structure also comprises, in the extension of the lining 12, a first frame 13 that defines the upper outline of the door.

Conventionally, a handle or grip 111 is provided on the external panel and on the lining to actuate the door-opening system, not shown on these figures. A slot 14 is provided between the top of the lining 12 and the height of the external panel 11, along a large part of the structure 1. The slot 14 enables the passage of a mobile glass window in the interior space 15 of the structure, situated between the external panel 11 and the lining 12 of the structure 1. This door structure can classically also comprise systems of reinforcement against frontal or side impacts, that are not shown herein.

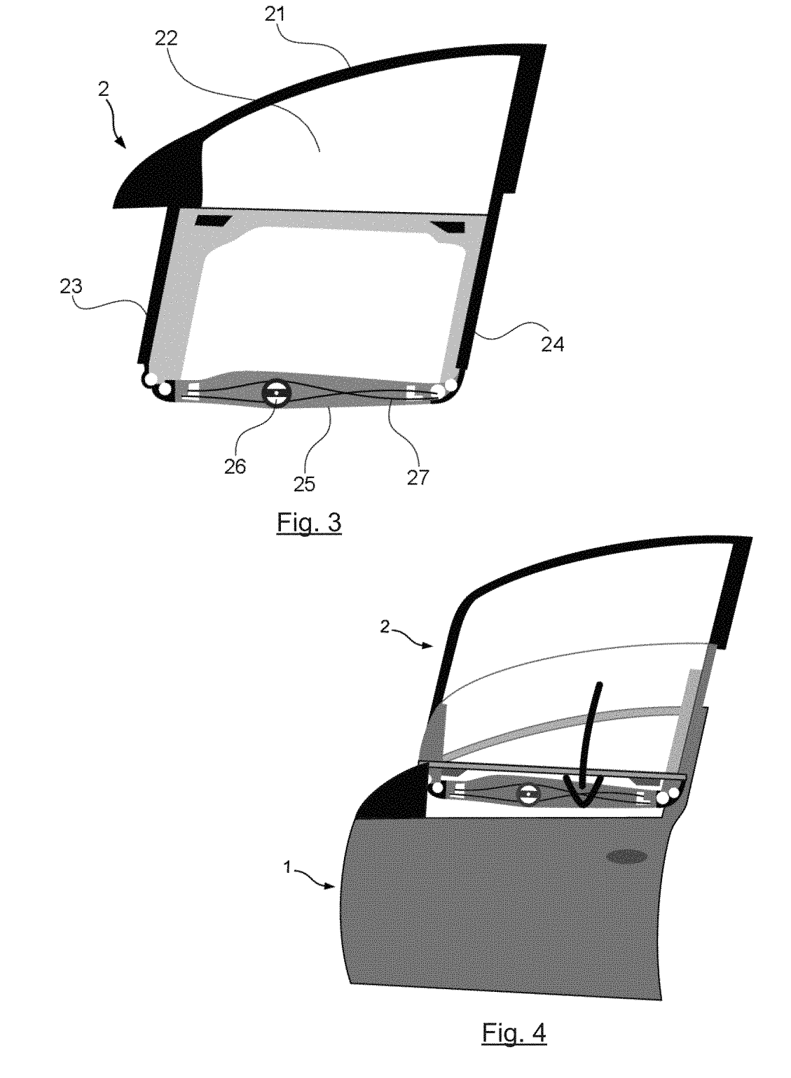

FIG. 3 shows the glazed unit 2 that is to be joined with the structure 1 to form the door of the vehicle. This unit 2 comprises a second frame 21 which appreciably has the same shape as the first frame 13 of the structure 1.

A mobile glazed panel 22, in closed position, covers or overlaps the space defined by the frame 21 and also covers at least one portion of the frame 21 itself, thus making it possible to obtain a flush glazed surface seen from the exterior.

In the extension of the two uprights of the frame 21, they extend two extensions 23 and 24. The purpose of these extensions is to guide and maintain the mobile glazed panel 22 in its movements between the open and closed positions, and play a part in the fixed attachment of the two units.

The lower part of these two extensions can be connected by a cross member 25. This cross member 25 can support a motor 26 to actuate the mobile glazed panel.

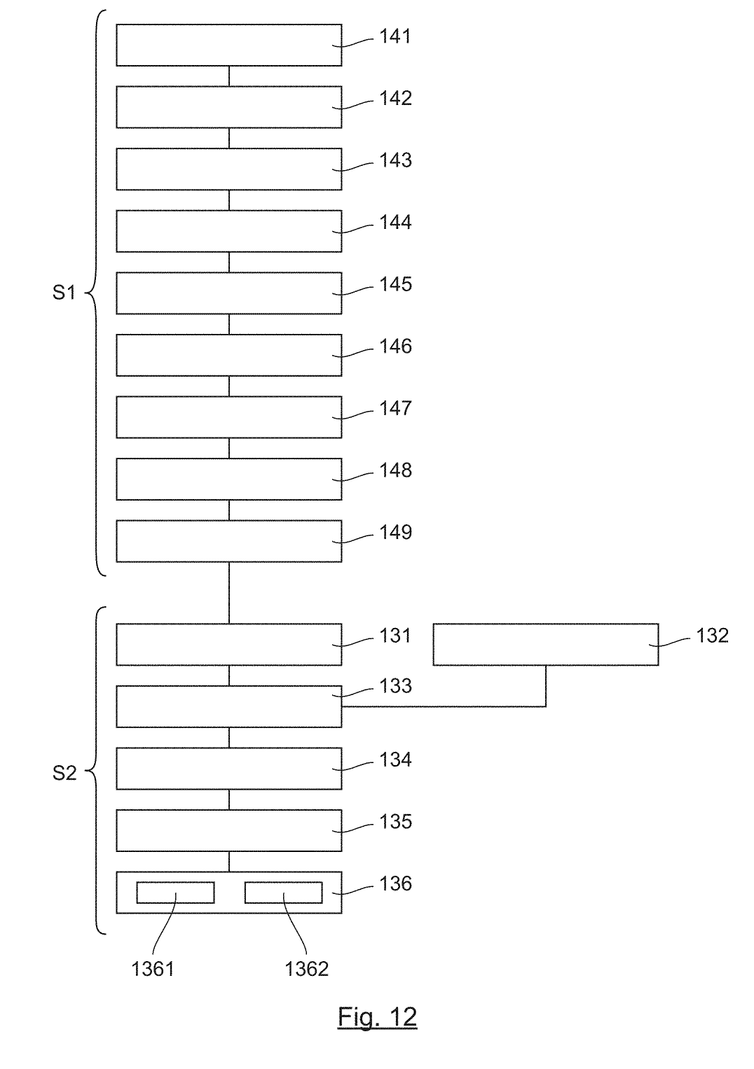

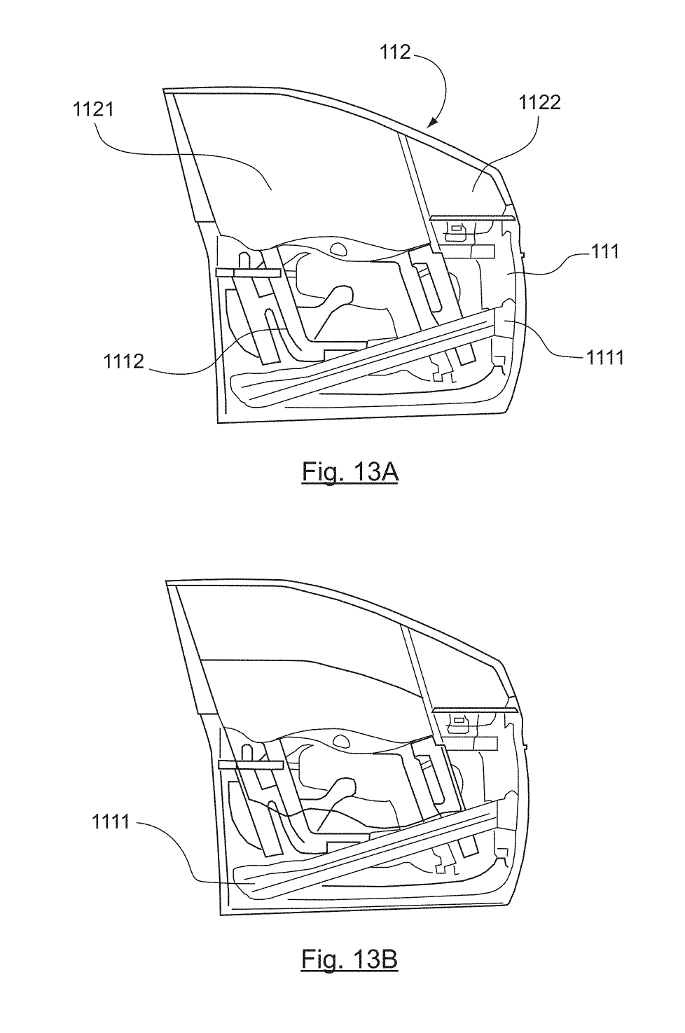

FIGS. 11 and 12 respectively present a side rear-view mirror and the upper corner of an automobile door. As can be seen in these figures, the glazed panel can replace or integrate the B-pillar and rear-view mirror trim moldings. The glazed unit 2 can also include one or more fixed glazed panels, or rear quarter panels. Finally, it can integrate the frame and door gaskets.

Thus, the upper unit is a complete unit provided by the manufacturer to the builder in “ready-to-assemble” form already equipped with its accessories, its engine etc. These different elements have been preliminarily adjusted, provided with settings and tested.

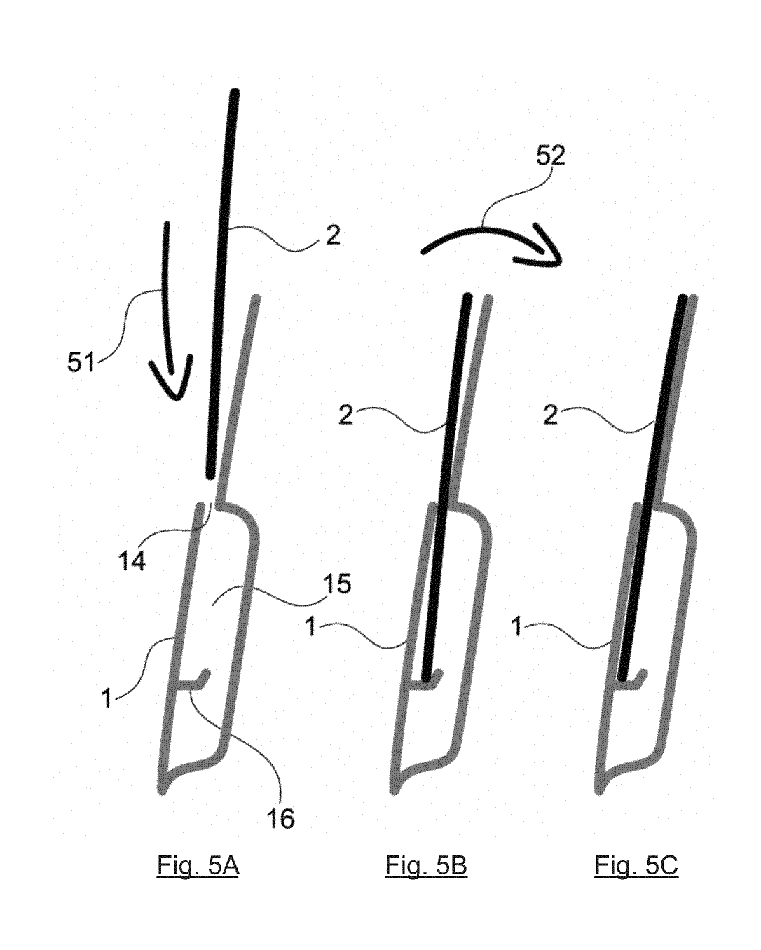

FIG. 4 and FIGS. 5A, 5B and 5C represent the mounting of these two elements constituting a door of the motor vehicle according to the invention. The figures show the structure 1 and the glazed unit 2, the mobile glazed panel of which is shown herein in an open position. During assembly, as can be seen in FIGS. 4 and 5a, the extensions 23 and 24 of the glazed unit 2 are introduced (51) into the interior space 15 through the slot 14 of the structure 1.

Then, as can be seen in FIG. 5b, a slight rotation 52 enables, on the one hand, the extensions 23 and 24 of the glazed unit 2 to be placed flat against the interior of the panel 1 and, on the other hand, the second frame 21 of the glazed unit 2 to be placed flat against the first frame 13 of the structure-forming unit 1.

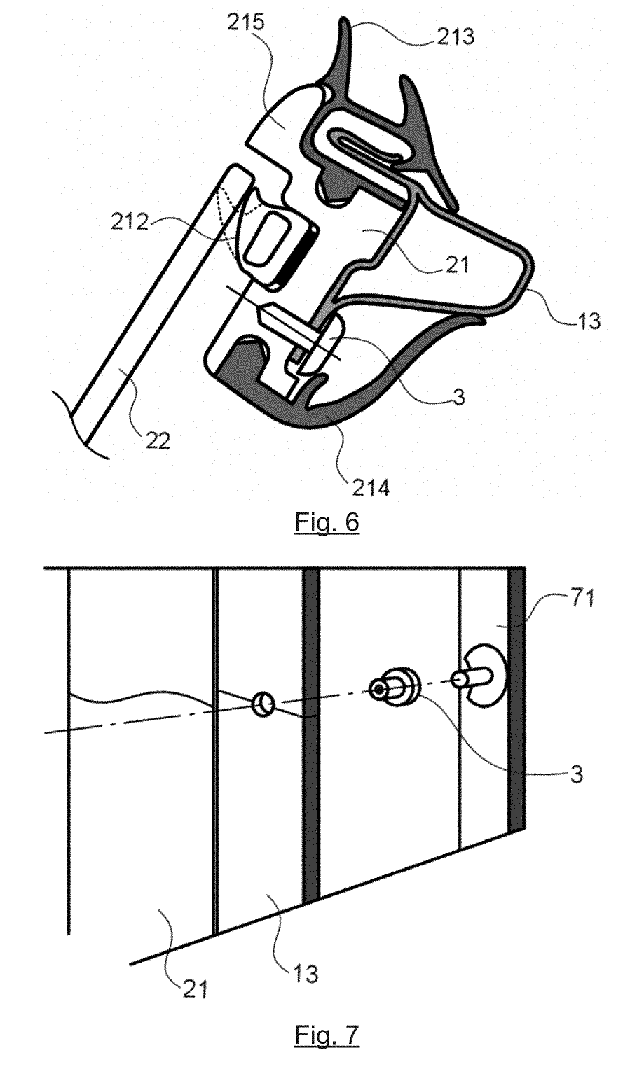

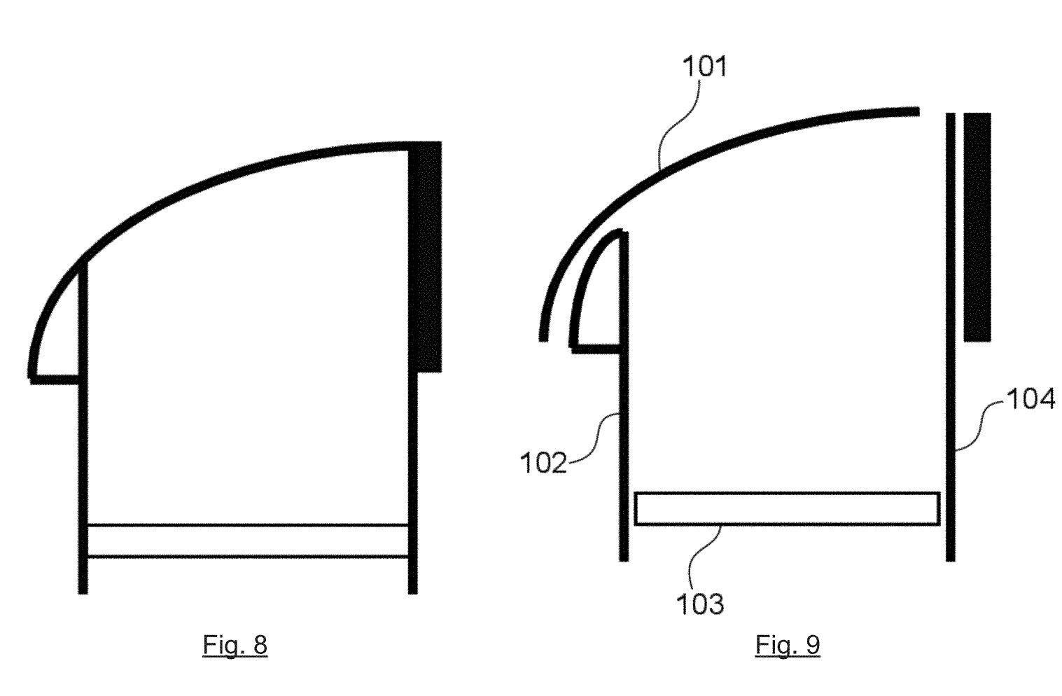

Since these two frames have essentially the same shape, they overlap each other perfectly. This is illustrated by FIG. 6, which shows a partial section of these frames 13 and 21 fixed to each other. These frames are assembled for example by plastic clip-on means 3 to prevent the problems of galvanic corrosion or galvanic effect.

This plastic clip-on system 3 is also shown in FIG. 7. The plastic clip-on staples can be covered by a plastic strip 71 forming a trim molding.

The fastening can include system of compensation for play, not shown in the figures, in order to prevent noise between the first frame 13 of the structure-forming unit 1 and the second frame 21 of the glazed unit 2. In addition, a settings system, not shown in the figures, can be integrated for the adjustment of the flush appearance and the clearances of the frame relative to the surrounding elements.

According to another embodiment, the two frames 13 and 21 can also be assembled by gluing using glue or a double-sided adhesive tape.

The mobile glazed panel 22, in closed position, rests against the second frame 21 of the glazed unit 2 which itself appreciably covers the first frame 13 of the structure 1. A part 215 of the frame can form a trim molding between the glazed panel and the bodywork. In this case, this part is flush with this glazed panel (in the closed position) and the bodywork.

As can be seen in FIG. 6, the second frame 21 can also include several gaskets. The window gasket 212 is fixed in a groove of the frame 21 so as to be concealed beneath the glazed panel 22 when this panel is closed. This sealing gasket is then compressed between the second frame 21 and the glazed panel 22, which provides efficient sealing. A double door seal 213 can also be fixed to the second frame 21. This frame can also serve as a support for an interior upholstery of the vehicle 214.

The power system for actuating the movement of the glazed panel 22 can be obtained in several ways.

One embodiment can consist of a motor-reduction gear and a rail fixed to the door shell used to guide the drive system a (e two-way push-pull cable for example). In this case, the system of cables is directly linked to the lower part of the glass window, ideally at its center.

Another embodiment can consist of a motor-reduction gear and a drive system (push-pull cable for example connected to the sliding skids of each of the two uprights of the frame. This solution is advantageous because it eliminates the central rail and enables an easier mounting of the frame in the door shell: since the frame is pre-equipped with the power system, the unit is “threaded” between the external panel and the lining of the body.

The power system can be electronically commanded to manage for example the impulses, variable transfer speeds and an anti-clamping device. Naturally, the actuation of this mobile glazed panel can also be designed to be actuated by hand without necessarily modifying the general principle of the closing and opening of the mobile glazed panel 22.

As can be seen, in the door, the holding of the mobile glazed panel 22 and its guidance between its open position and its closed position are entirely provided by the glazed unit 2. This unit however does not have to ensure the rigidity of the frame, which is entirely provided by the structure-forming unit 1.

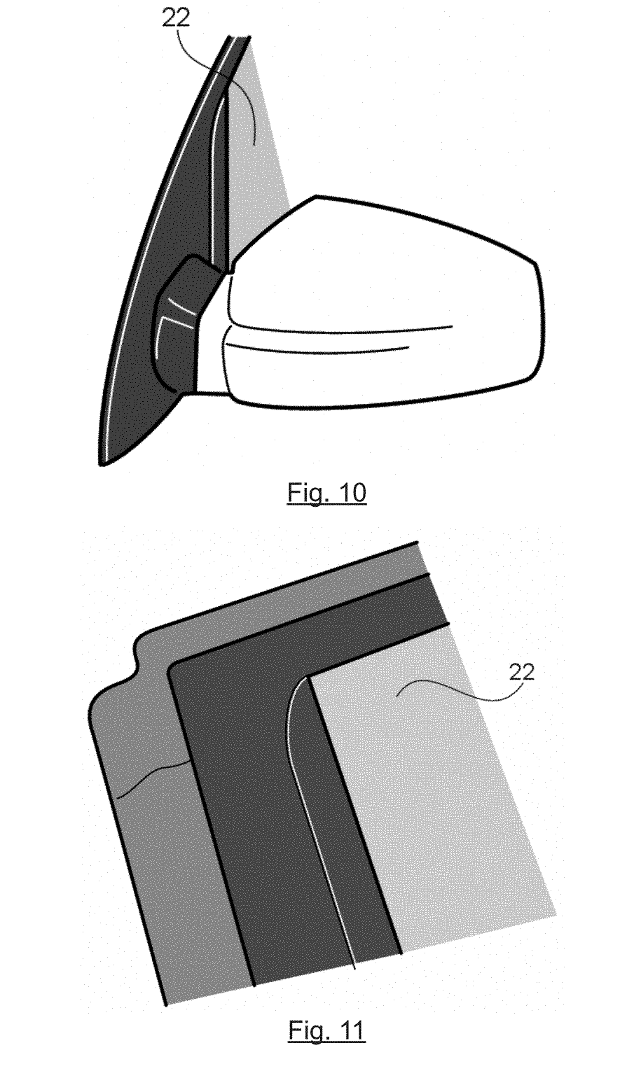

This therefore leaves several possibilities for manufacturing the frame 21. Indeed, it can either be a monoblock frame (for example made of plastic), as illustrated schematically in FIG. 9 and can directly fulfill the function of slide rails, grooves for maintaining tight sealing, swiveling ramps, or it can be formed of several parts as shown schematically in FIG. 10, with welded links (for example made of steel). In this case, there are two possible configurations:
making a frame with the front upright 102, the rear upright 104, the upper enclosure 101 and the powered cross member 103;
making a U-shaped frame with the front upright 102, the rear upright 104 and the powered cross member 103, the frame-closing element 101 being delivered separately to the builder in order to be directly joined to the top of the door frame (affixing by crimping, clinching or soldering).

FIG. 12 gives a view, in the form of a graph, of the different operations for manufacturing a motor vehicle door according to the invention.

Two major phases or steps, S1 and S2, can be distinguished: a phase S1 for manufacturing the upper unit, for example at a manufacturer's or sub-contractor's plant and a joining phase S2, for example at an automobile-maker's plant.

The approach of the invention enables the phase S2 to be very simple and speedy and especially frees the automobile-maker from the need to carry out numerous settings of the mobile panel and of the sealing elements, since these aspects will have been preliminarily carried out by the sub-contractor during the step S1. The manufacturer thus has a “ready-to-work” upper unit.

The step S2 can include an operation 131 for obtaining or receiving the structure-forming unit 1. The manufacturing of this unit can be classic and is not described in detail here. It can be carried out by the automobile-maker or by a separate manufacturer. This structure-forming unit can be made for example out of sheet metal and it includes a door structure equipped especially with an external panel 11, an internal lining 12 with structural frame adapted to the present invention (with preparation for affixing), different reinforcement pieces (against frontal and side impacts) and closing systems (latch, link-rod etc.). This operation also includes the painting of the structure-forming unit 1.

Another operation 132, for receiving the glazed unit, is carried out during the step S1, and may be done totally independently of the operation 131 described here above. In particular, this operation can be carried out by a manufacturer or an independent sub-contractor at another site. This is the object of the step S1.

This step S1 is aimed at producing a glazed unit formed by a frame 21 which can be either a monoblock unit, for example made of plastic, or formed by several elements assembled by soldering, for example, made out of steel. This frame is especially equipped with one (or more) mobile glazed elements 22, possibly one or more fixed glazed elements, rear quarter window or windows, frame and door sealing gaskets, grooves 211 which may be attached to or emerge from the frame, sliding skids and if necessary a manual or power driven system, trim moldings forming continuity between the glazed parts and/or the rest of the vehicle, a rear-view mirror etc.

It therefore comprises especially the following sub-steps:
manufacturing or obtaining 141 the frame 21;
mounting and/or forming 142 two guide rails on this frame 21;
obtaining 143 a mobile glazed panel;
mounting at least two guide skids 144 on the face of the mobile glazed panel that points into the interior of the vehicle;
assembling 145 the skids on the rails, so that they slide in these guide rails, to drive a mobile panel between a closed position and at least one open position, said mobile glazed panel resting, in the closed position, against said frame, so that the latter is situated between said first frame and said mobile glazed panel;
setting 146 the position of at least one of the skids relative to said mobile glazed panel so as to enable the sliding of said skids in said rails,
positioning 147 sealing elements (between the mobile panel and the frame and between the frame and the body of the vehicle);
positioning 148 other elements, if necessary, depending on the doors (rear view mirrors, trim moldings, fixed glazed elements, power drive etc.);
positioning 149 a moveable stop that blocks the mobile panel in the closed position when it is being transported and assembled (S2).

The mounting of the mobile glazed panel on the rails is specified in section 2.

Once this glazed unit 2 is thus pre-assembled, the manufacturer can supply it in a “ready to mount” condition to the car-maker who will carry out the final assembling (step S2).

For the final assembling, the glazed unit 2 is inserted (134) into the structure-forming unit 1 between the external panel 11 and the lining 12, as illustrated in FIGS. 5A to 5B. It can be noted that this operation can be carried out when the structure-forming unit has already been painted.

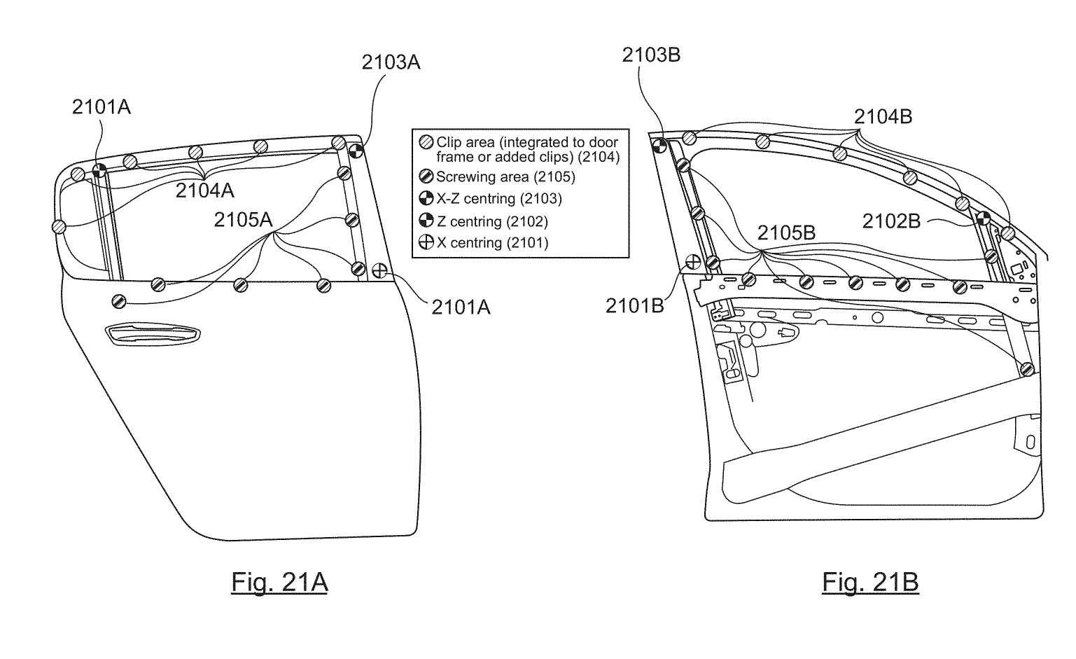

A precise positioning 135 of the two units 1 and 2, one relative to the other, and especially of the first frame relative to the second frame, is carried out by means of centering means as shown in FIGS. 21A and 21B which schematically represent a rear door and a front door of a vehicle.

To this end, in the embodiment illustrated, complementary centering elements 2101A, 2101B, 2102A, 2102B, 2103A, 2103B are provided. More specifically, each door frame comprises:
a centering element for centering along X (the horizontal direction along the length of the vehicle) 2101A and 2101B;
a centering element for centering along Z (the vertical direction along the height of the vehicle) 2102A and 2102B;
a centering element for centering along X and Z, 2103A and 2103B.

These centering elements are preferably distributed in three of the corners of the frames to be assembled. The operator can thus easily position the frames relative to each other.

At this level, in certain embodiments, a setting operation can be integrated in order to adjust the flush and the clearances of the second frame 21 relative to the surrounding elements (for example relative to the two doors).

The second frame 21 is then fixedly attached (136) to the first frame 13 of the structure-forming unit 1. This fixed attachment is done for example, on the one hand, by a plastic clip-on system 1361 (to avoid problems of galvanic corrosion or galvanic effect) with compensation for play (to avoid noise between the first structural frame 13 and the second glazed frame 21) and, on the other hand, by screwing 1362.

The plastic clip-on system 1361 can be obtained by clips that are independent or integrated into one of the frames. In the embodiment illustrated, the clip-on areas 2104A and 2104B are distributed at five or six points on the upper part of the frames and on one of its sides.

A screwing operation 1362 is planned at six to ten screwing points 2105A and 2105B on the lower part of the frames and on the other of the sides and if necessary inside the body (FIG. 21B).

In one variant, it is possible to envisage bonding with double-sided adhesive tape or gluing on the interface between the components and between the second glazed frame 21 and the first frame 13 in order to have compact assembly.

It can clearly be seen that the novel technique of the invention has several advantages:
obtaining a glazed surface that is complete and flush with the surrounding glazed elements and the bodywork, thus enabling the definition of new styles for the vehicles, and possible adjustment of this flush;
simplifying assembly by the pre-assembling of the unit for which all that needs to be done is to insert it into the door shell (even the tests and settings can be done beforehand);
eliminating and simplifying parts by multi-functional integration. For example, elimination of the trim moldings for the B-pillar and the rear-view mirror base, simplifying the sealing gaskets;
simplifying maintenance since it is no longer necessary to remove the seals during the dismantling the mobile panel, and since the glazed unit can be changed to take the form of a single unit (glass window+frame);
reducing wear and tear on the seals which are not in contact with the mobile panel when it is sliding;
improving the drag coefficient (Cx), which leads to a reduction of fuel consumption by the vehicle.

Numerous additions and variants of the embodiment described here above can of course be envisaged.

### 2. Mounting the Mobile Glazed Panel

FIGS. 13A and 13B illustrate another example of a front side door, from which the mounting of the glazed panel is now described.

This door classically comprises a lower part 111, called a door shell, forming the structure of this door. In the figures, the external element of the bodywork is omitted to reveal the interior of this body, which comprises especially a reinforcing upright 1111 and elements 1112 for receiving and holding the glazed upper part.

This glazed upper part comprises a mobile part 1121 that can be moved from a closed position (FIG. 13A) to an open position (FIG. 13B). In the embodiment illustrated, it also comprises a fixed element 1122 corresponding here to the part oriented towards the front of the vehicle.

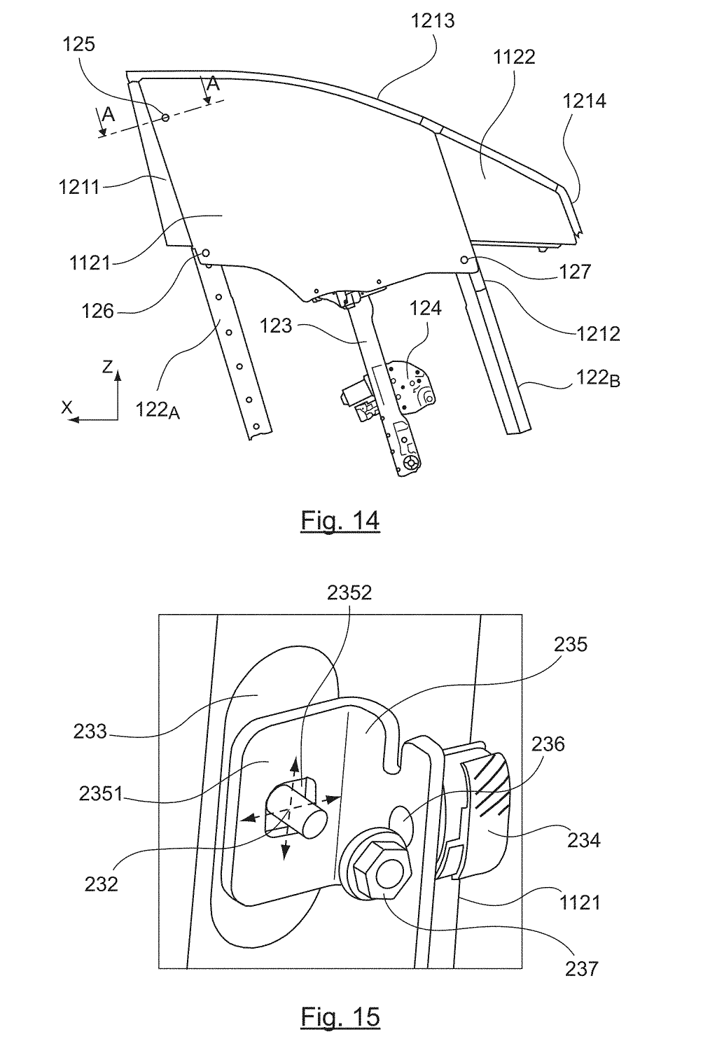

This glazed part 112 can be made independently, as illustrated by FIG. 14, and then joined with the body 111 to form the door.

It comprises a frame 121 herein formed by two uprights 1211 and 1212, each associated with a rail 122A, 1228, an element 1213 following the curve of the upper part of the glazed part and a front element 1214 associated with the fixed glazed part 1122. The frame can carry a sealing gasket.

The mobile panel 1121 is driven in movement by driving means 123, for example a rack-and-pinion mechanism itself actuated by an electric motor 124. Other driving means, including manual driving means, can of course be implemented.

In FIG. 14, the glazed part is seen from the exterior. It can be seen that the frame 121 (especially the uprights 1211 and 1212) extend beneath the mobile panel 1121, i.e. towards the interior of the vehicle. Guiding skids are fixed to the face of the mobile panel 1121 oriented towards the interior of the vehicle, to cooperate with the rails 122A, 1228. Although in practice they are generally not visible from the exterior (since the corresponding area is screen-printed), their positions have been shown in FIG. 14. In this embodiment, two skids 125 and 126 are provided in order to cooperate with the rail 122A oriented towards the rear and a single skid 127 is provided in order to cooperate with the rail oriented towards the front 1228.

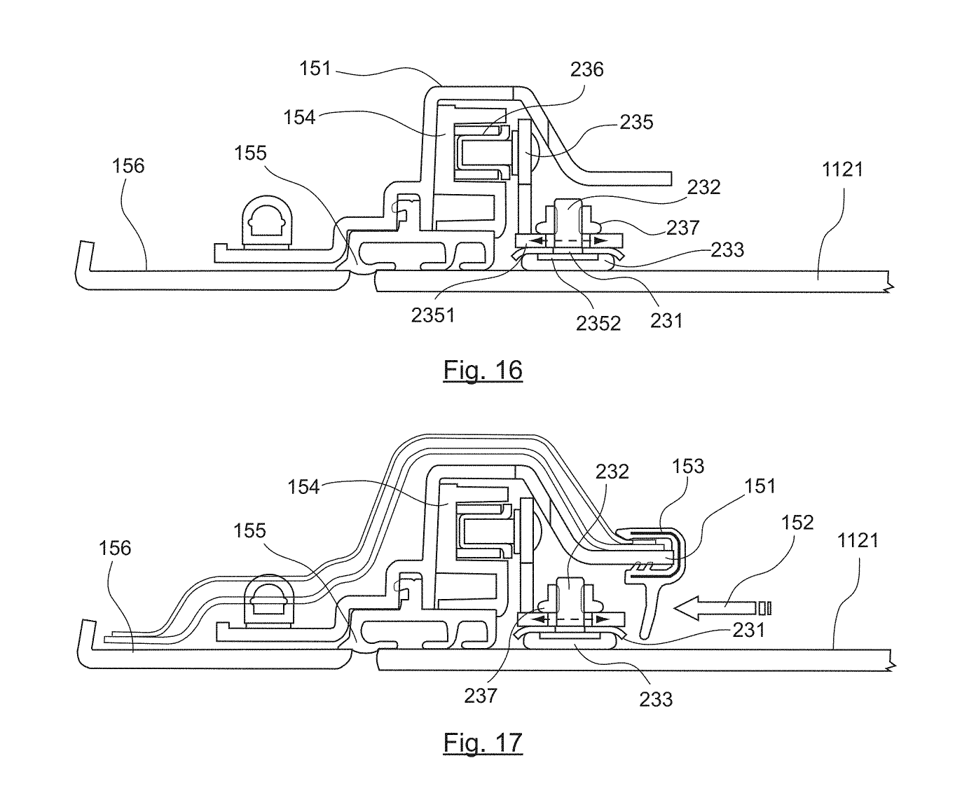

As illustrated in FIG. 15 and in FIG. 16, which are views in section AA at the level of the skid 125 (see FIG. 14), the invention provides for the precise setting of the position of the skid relative to the mobile panel. To this end, the mobile panel 1121 carries, at each skid, a saddle 231 with a stud 232 fixedly attached by gluing 233 to the surface of the glazed panel 1121 that is oriented toward the interior of the vehicle.

The skid 234 is mounted on a skid support 235, here through a pin 236 enabling the skid to be angularly mobile, especially to follow the swiveling movement described here below.

The skid support 235 has a deck 2351 extending in parallel to the mobile panel 2121 and having an aperture 2352 that is to cooperate with the stud 232. This aperture 2352 has an area appreciably greater than the diameter of the stud 232, thus enabling the position of this stud relative to the aperture to be adaptable and, therefore, enabling the setting of the position of the skid 234 relative to the glazed panel 1121.

This setting is therefore particularly easy and can be made with precision. Once this setting is made, the position of the stud relative to the aperture is blocked. To this end, the stud 232 has a screw thread and can receive a nut 237.

As illustrated in FIG. 17, the blocking or unblocking of this nut 237 can be done easily, by means of a suitable tool sliding under the frame 151 (arrow 152) before the lining seal 153 is positioned. A new setting can be made later, if needed, by removing the lining seal 153.

As indicated here above, the frame 151 carries a rail 154. It also receives a sealing gasket 155 as well as a trim molding element 156 extending in the plane of the mobile panel 1121 when it is in the closed position.

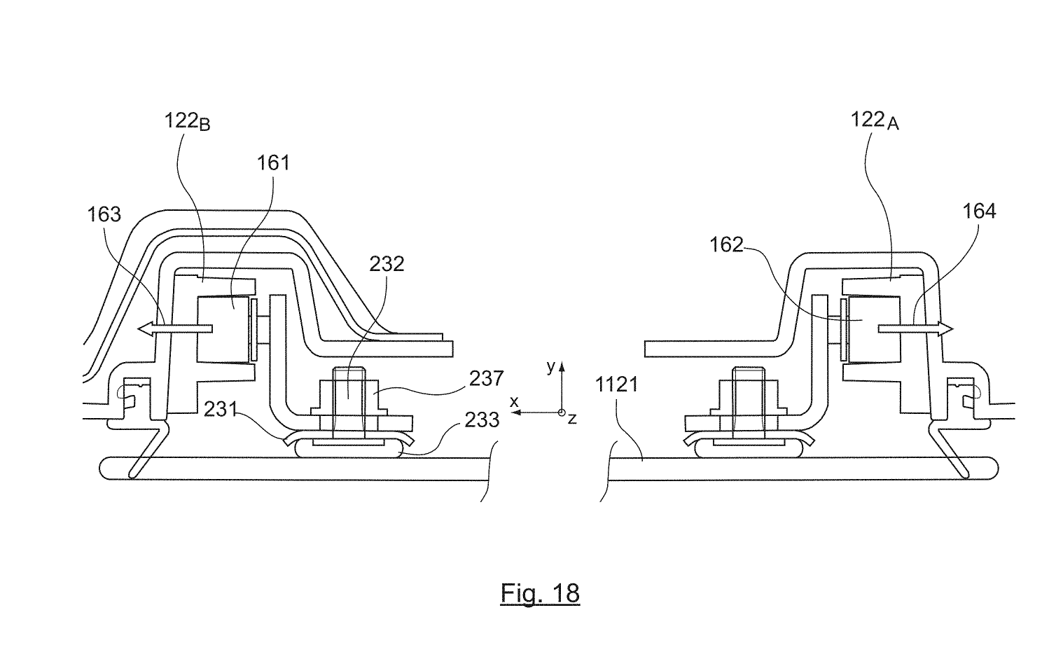

According to this first mode of implementation, illustrated by FIG. 18, the three skids 161 (rear skid) and 162 (front skid) are similar, and for example of the type illustrated in FIG. 15.

The rails 1228 and 122A fulfill the dual function of guidance in translation and swiveling. The swiveling, which is not imperative in all embodiments, enables a slight shifting of the mobile panel towards the exterior before it is shifted in translation, so as to release the seals to facilitate their movement and limit their deterioration.

The rear skid 161 and front skid 162 push in opposite directions (arrows 163 and 164) close to an axis X (corresponding to the length of the vehicle). They also carry out the guidance in the direction Y (width of the vehicle) for the swiveling.

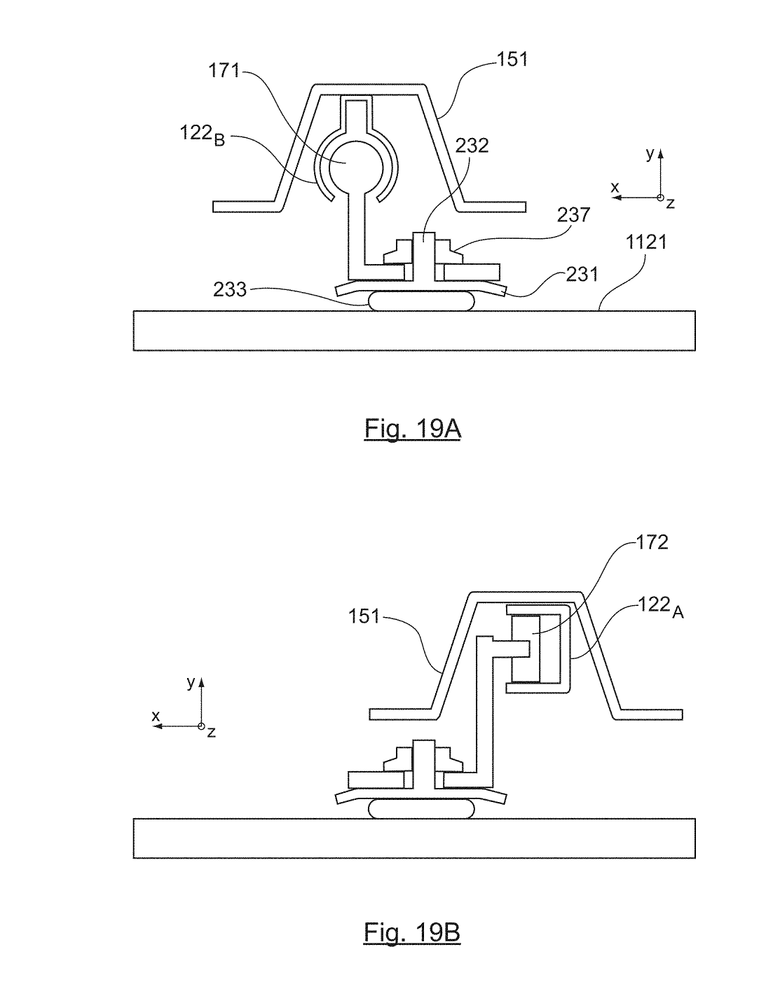

FIGS. 19A and 19B present a variant of implementation of the skids. The front skid 172 (FIG. 19B) and its operation are similar to the skid 162 already described with reference to FIG. 18.

By contrast, the rear skids 171, in this embodiment, present an essentially cylindrical section. The rail 1228 has a complementary, essentially cylindrical shape. Thus, while the front skid 172 carries out guidance strictly along Y, the rear skids 171 guide the glass window along X and Y, the respective sections of the skid and the rail enabling a rotation of the mobile panel about the Z axis.

In this case, the skids have an essentially cylindrical shape and the rail 1228 has a complementary, essentially cylindrical shape. The mobile part 1121 can, if need be, move slightly and thus integrate a door shape that is not perfectly cylindrical.

Other sections can of course be used without departing from the framework of the invention. These can be any section whatsoever and, for example, can be square or rectangular. In any case, they enable settings to be made in at least one of two directions, along X and/or along Y.

Finally, according to another optional aspect, means are planned for applying stress to the mobile panel in its closed position. Indeed, since the mobile panel is not maintained in the upper part, it can tend to move away from its theoretical position. Generally, to combat this phenomenon, the rear glass window has a greater bulge than the theoretical glass window, to compensate for this effect.

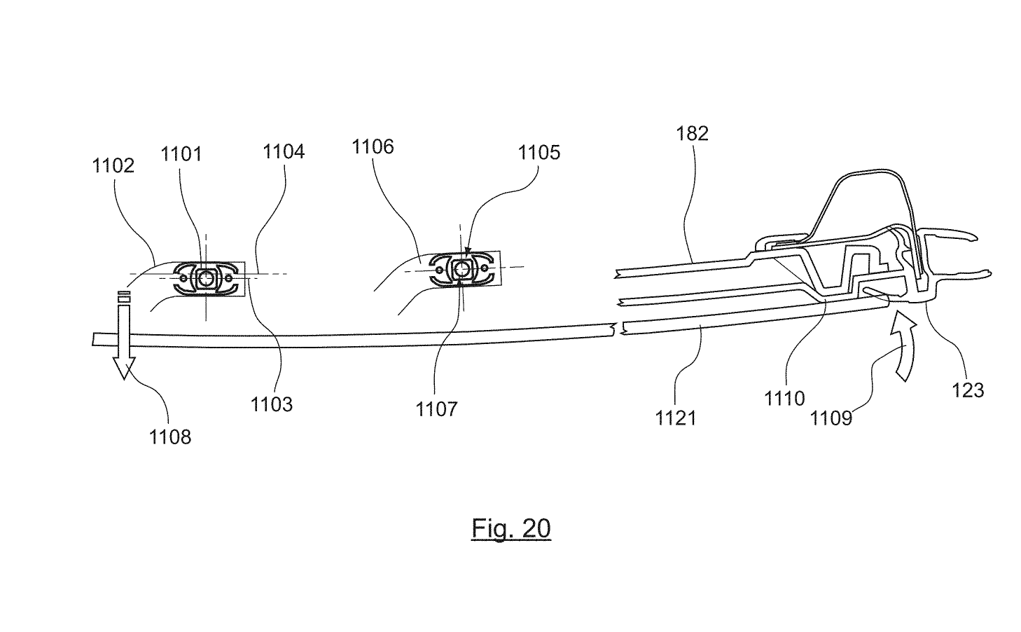

According to this optional aspect of the invention, illustrated in FIG. 20, action is taken on the lower skid 1101 so that its position in the rail 1102 is slightly offset outwards from the vehicle (axis 1103) relative to the theoretical position (axis 1104). The upper skid 1105 for its part is guided in the rail portion 1106 in compliance with its theoretical position. Its axis 1107 thus forms an axis of rotation for the mobile panel.

Owing to the offset between the axes 1104 and 1103, a force 1108 is applied to the bottom of the mobile panel 1121 towards the exterior of the vehicle. The mobile panel therefore tilts very slightly about the axis 1107 of the upper skid 1105, thus making sure that the upper part of the mobile panel 1121 is placed flat (arrow 1109) against a stop 1110 fixedly attached to the frame 182.

The stop 1110 can especially be fixedly attached to the frame, an upright or a slide seal.

Thus, the mobile panel 1121 is stressed against the stop 1110, and therefore substantially maintains the desired theoretical position.

### Advantages of the Invention

According to embodiments of the invention, it is provided vehicle doors:
that have a flush appearance in themselves and with the bodywork, while having a large glazed surface opening;
that have high structural and sealing quality;
that provide for novel characteristics, especially in terms of esthetics and ergonomic quality;
that are simple and easy to implement and, in particular, that car manufacturers can assemble, adjust and mount on the vehicle efficiently and speedily, for example on an assembly line; and/or
that can be easily held or replaced, for example following an accident.

1. Motor vehicle door comprising a structure-forming unit and a glazed unit assembled with each other,
wherein said structure-forming unit has a first frame and in that said glazed unit has a second frame, said first frame and said second frame being essentially superimposed,
wherein said first frame and/or said second frame bear at least one complementary centering element enabling them to be assembled, each centering element controlling the position of the second frame relative to said first frame along at least one direction,
in that said first frame and/or said second frame bear fixed-attachment elements enabling definitive attachment to each other
wherein said second frame comprises two guide rails slidingly guiding a mobile glazed panel between a closed position and at least one open position, said mobile glazed panel resting, in closed position, against said second frame such that the latter is situated between said first frame and said mobile glazed panel
wherein said mobile glazed panel bears, on its face oriented towards the interior of the vehicle, at least two guide skids, each mounted so as to be sliding relative to one of said guide rails,
wherein the position of at least one of said skids relative to said mobile glazed panel is adjustable.

2. Motor vehicle door according to claim 1, wherein said centering elements comprise an element for centering in a direction X that is substantially horizontal and substantially in the general plane of said door and an element for centering in a substantially vertical direction Z.

3. Motor vehicle door according to claim 1, wherein said centering elements comprise an element for centering in two substantially perpendicular directions, one direction X that is substantially horizontal and substantially in the general plane of said door, and one substantially vertical direction Z.

4. Motor vehicle door according to claim 1, wherein said fixed-attachment elements comprise screws.

5. Motor vehicle door according to claim 1, wherein said fixed-attachment elements comprise clips.

6. Motor vehicle door according to claim 1, wherein each of the skids of adjustable position is mounted on a skid support cooperating with a stud fixedly attached to said mobile glazed panel.

7. Motor vehicle door according to claim 6, wherein said skid support advantageously has an aperture crossed by said stud, the dimensions of said aperture being greater than the diameter of said stud so as to enable a shifting of settings relative to each another in at least one of two directions defining the plane of said glazed panel in the vicinity of said stud.

8. Motor vehicle door according to claim 1, wherein said glazed unit has at least one extension that is to penetrate the interior of said structure-forming unit.

9. Motor vehicle door according to claim 1, wherein said glazed unit bears powering means for driving said glazed panel mounted on a cross member connecting said extensions.

10. Motor vehicle door according to claim 1, wherein said second frame is a monoblock frame.

11. Method for manufacturing and assembling a motor vehicle door, comprising a structure-forming unit and a glazed unit assembled with each other,
said structure-forming unit having a first frame and said glazed unit having a second frame,
the method comprising a step for manufacturing said glazed unit, comprising steps of:
mounting and/or forming two guide rails on said second frame, these two guide rails being capable of slidingly guiding a mobile glazed panel between a closed position and at least one open position, said mobile glazed panel resting, in closed position, against said second frame so that the second frame is situated between said first frame and said mobile glazed panel,
mounting at least two guiding skids on the face of said mobile glazed panel oriented towards the interior of the vehicle, each guiding skid being mounted slidingly, relative to one of said guide rails,
placing said skids in said rails,
setting the position of at least one of said skids relative to said mobile glazed panel so as to enable the sliding of said skids in said rails, and a step of assembling so as to superimpose said first frame and said second frame comprising the steps of:
placing said second frame relative to said first frame by means of at least one centering element provided on said first frame and/or said second frame and controlling the position of the second frame relative to said first frame according to at least one direction,
fixedly attaching said first frame to said second frame enabling definitive fastening to each other.

12. Method for manufacturing and assembling according to claim 11, wherein said step for manufacturing said glazed unit is made at a first place so as to provide a pre-equipped glazed unit and in that said assembling step is performed by an automobile manufacturer without requiring a setting of the mobile glazed panel relative to said structure-forming unit and the chassis of said vehicle.

13. Method for manufacturing and assembling according to claim 12, wherein said step of manufacture comprises a step for positioning a movable stop that blocks said mobile panel in the closed position during its transport and said step of assembling.

14. Motor vehicle comprising at least one door comprising a structure-forming unit and a glazed unit assembled with each other,
wherein said structure-forming unit has a first frame and in that said glazed unit has a second frame, said first frame and said second frame being essentially superimposed,
wherein said first frame and/or said second frame bear at least one complementary centering element enabling them to be assembled, each centering element controlling the position of the second frame relative to said first frame along at least one direction,
wherein said first frame and/or said second frame bears fixed-attachment elements enabling definitive attachment to each other,
wherein said second frame comprises two guide rails slidingly guiding a mobile glazed panel between a closed position and at least one open position, said mobile glazed panel resting, in closed position, against said second frame such that the latter is situated between said first frame and said mobile glazed panel,
wherein said mobile glazed panel bears, on its face oriented towards the interior of the vehicle, at least two guide skids, each mounted so as to be sliding relative to one of said guide rails,
wherein the position of at least one of said skids relative to said mobile glazed panel is adjustable.
